(19) United States
(12) Patent Application Publication
(10) Pub. No.: US 2009/0020659 A1
(43) Pub. Date: Jan. 22, 2009

(54) Cymbal mountable microphone mounting device

(75) Inventor: Kevin Henri Crous, Centurion (ZA)

Correspondence Address: Charles N. J. Ruggiero;Ohlandt, Greeley, Ruggiero & Perle, L.L.P., One Landmark Square, 10th Floor, Stamford, CT, 06901-2682, US

(73) Assignee: Kevin Henri CROUS and Yuri John SERFONTEIN

(21) Appl. No.: 11/895,858

(22) Filed: Aug. 28, 2007

(30) Foreign Application Priority Data
Jul. 18, 2007 (ZA) 2007/05876

(51) Int. Cl. G10G 5/00; F16M 11/00

(52) U.S. Cl. 248/125.8; 248/219.4

(57) ABSTRACT

The invention relates to a microphone mounting device for mounting a microphone to a musical instrument, and more particularly to a microphone mounting device suitable for mounting a microphone to a cymbal arrangement. The mounting device includes a body having a first end zone and a second end zone. The first end zone includes an engagement formation provided thereon for engaging the cymbal stand and the second end zone includes a threaded connector suitable for engaging a microphone assembly, the first end zone and the second end zone being displaceable relative to one another.

### FIELD OF THE INVENTION

The invention relates to a microphone mounting device for mounting a microphone to a musical instrument, and more particularly, but not exclusively, to a microphone mounting device suitable for mounting a microphone to a cymbal arrangement.

### BACKGROUND TO THE INVENTION

A cymbal is a musical percussion instrument, and typically comprises a thin metal plate formed in a somewhat concave form, and including a cup-like bell section at a central zone thereof. A sound is generated by hitting two opposing cymbals against one another, or alternatively by hitting the cymbal with a drumstick or similar device.

Two types of cymbal arrangements are generally used in drum sets, being the hi-hat cymbals, and the suspended or crash cymbals. The hi-hat cymbal comprises two oppositely orientated cymbals that can be displaced away and towards one another so as to generate a sound by abutment of the edges of the two cymbals. A suspended or crash cymbal is loosely mounted on a microphone stand, and is hit with a drumstick or similar device to generate a sound.

In use it is often required to amplify the sound emanating from a cymbal, which sound is then picked up by a microphone located proximate the cymbal. Due to the nature of cymbals (i.e. due to the fact that it does not have a suitable rim or similar formation onto which a microphone bracket can be secured), not many types of microphone mounting devices are know in industry. The mounting device generally used is the well-known freestanding microphone stand configuration. In this configuration, neither the microphone nor the stand is secured to the cymbal, and more particularly to the cymbal stand. A microphone stand is however space consuming and setting up and correctly positioning the microphone stand can also be a time consuming exercise. A freestanding microphone stand is furthermore expensive and unnecessarily complex.

### OBJECT OF THE INVENTION

It is accordingly an object of the invention to provide a microphone mounting device suitable for use with a cymbal arrangement which will, at least partially, alleviate the disadvantages mentioned above.

It is a further object of the invention to provide a microphone mounting device that will be a useful alternative to existing mounting devices.

### SUMMARY OF THE INVENTION

According to the invention there is provided a microphone mounting device, suitable for being connected to a cymbal arrangement that includes at least one cymbal and a cymbal stand, the mounting device including:
a body having a first end zone and a second end zone; the first end zone having an engagement formation provided thereon for engaging the cymbal stand; and the second end zone including a threaded connector suitable for engaging a microphone assembly;
the first end zone and the second end zone being displaceable relative to one another.

The first end zone and the second end zone may be telescopically displaceable relative to one another in order for the mounting device to be displaceable between a retracted position wherein the first end zone and the second end zone are displaced towards one another, and an extended position wherein the first end zone and the second end zone are displaced away from one another.

Preferably the mounting device is lockable in a selected position at or between the retracted and extended positions.

The body of the mounting device may include a tubular member and a rod member, the first end zone being located at an end of one of the members, and the second end zone being located at an end of the other of the members. Preferably the first end zone is located at the end of the tubular member, and the second end zone at the end of the rod member.

There is provided for the rod to be slideable within the tubular member so as to allow the first end zone to be telescopically displaceable relative to the second end zone.

In one embodiment of the invention the engagement formation is in the form of a tubular body having a threaded aperture provided therethrough, the tubular body being adapted to engage a complementary threaded protrusion extending through the cymbal. Preferably a locking member is provided, the locking member being adapted to engage the threaded aperture of the tubular body once the mounting device has been installed on the threaded protrusion, so as to lock the mounting device in position relative to the protrusion and thus the stand. Preferably the tubular body of the engagement formation is angularly offset relative to the body of the mounting device.

In another embodiment of the invention the engagement formation is in the form of a locating formation suitable for locating in a complementary profiled receiving formation provided on a clamping member secured to the cymbal stand. Preferably the locating formation is in the form of an end of a substantially L-shaped extension extending from the body of the mounting device. Preferably the L-shaped extension is substantially square in cross-section. There is provided for the clamping member to be any standard clamp known in the art.

### BRIEF DESCRIPTION OF THE DRAWINGS

Two preferred embodiments of the invention are described by way of non-limiting examples, and with reference to the accompanying Figures in which:

FIG. 1 is a perspective view of a first mounting device in accordance with the invention;

FIG. 2 is a perspective view of the mounting device of FIG. 1 secured to a hi-hat cymbal arrangement;

FIG. 3 is a perspective view of a second embodiment of the mounting device in accordance with the invention, the mounting device being in a retracted position;

FIG. 4 shows the mounting device of FIG. 3 in an extended position; and

FIG. 5 is a perspective view of the second embodiment of the mounting device as secured to a suspended cymbal arrangement.

### DETAILED DESCRIPTION OF THE INVENTION

Referring to the drawings in which like numerals indicate like features, a mounting device for use in various cymbal arrangements is generally indicated by reference numeral 10.

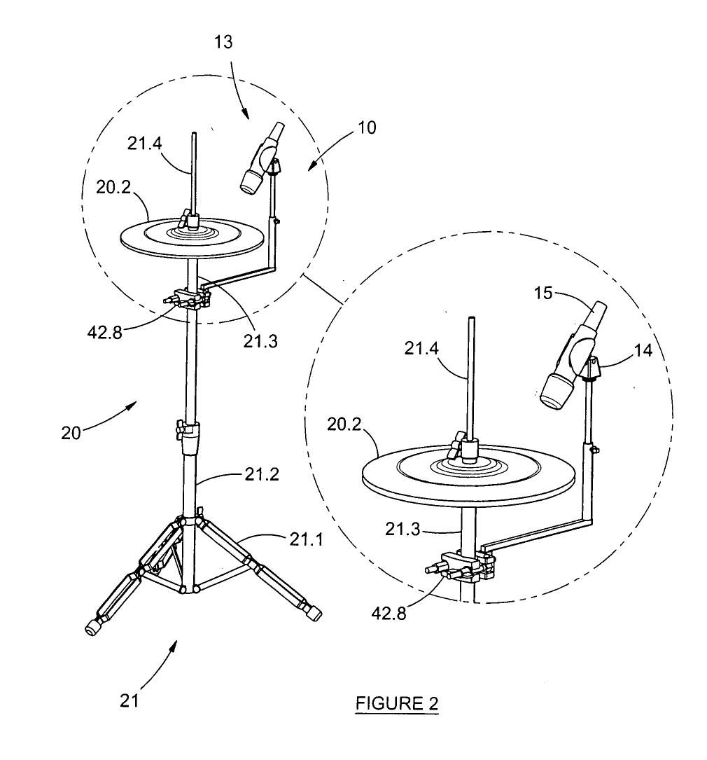

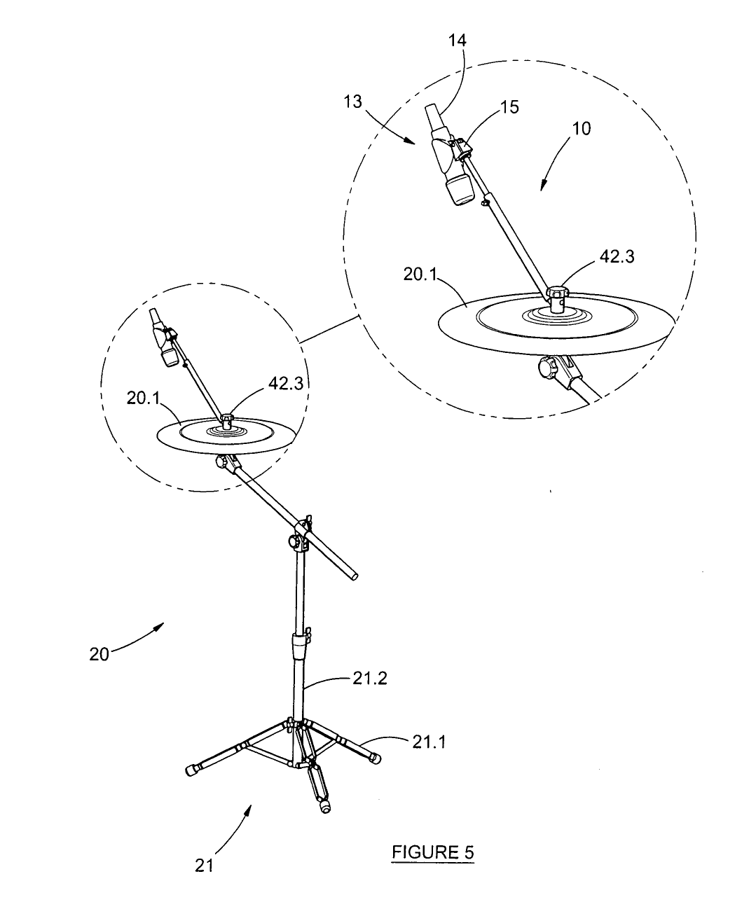

The mounting device 10 in accordance with the invention can be used, inter alia, with a suspended cymbal arrangement 20.1 as well as a hi-hat cymbal arrangement 20.2, as is shown in FIGS. 5 and 2 respectively.

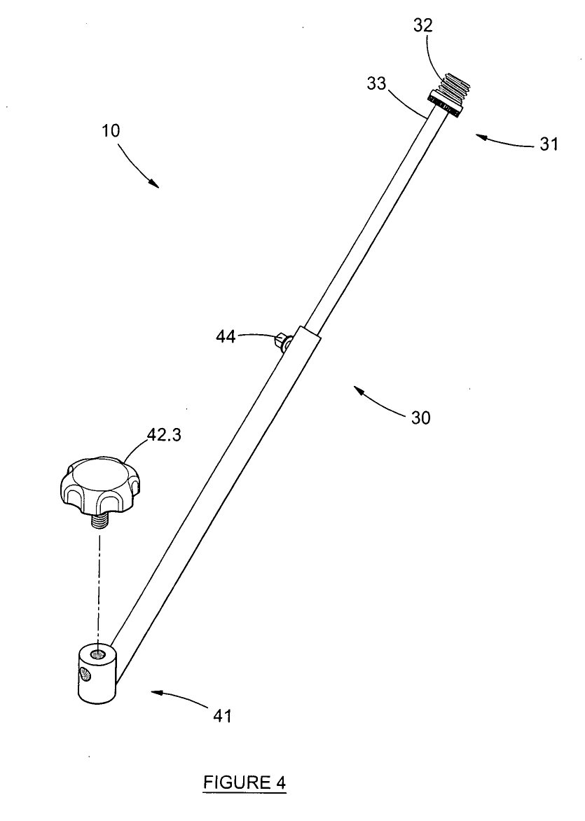

The mounting device 10 is used to position a microphone assembly 13 in the proximity of a cymbal, the microphone assembly 13 typically including a microphone holder 14, as well as a microphone 15 being releasably secured to the microphone holder 14. A cymbal arrangement 20, as seen in FIGS. 2 and 5, generally includes a cymbal (which may be a suspended cymbal 20.1 or of the hi-hat type 20.2), which is connected to a cymbal stand 21. The stand typically comprises a base 21.1, which is usually in the form of a foldable tripod and a telescopically extendable center post terminating in an end-section 31.3 onto which the cymbal is mounted. The end section 21.3 may also include a protrusion 21.4 and in use an aperture in the bell of a cymbal is slid over such protrusion in order to secure the cymbal to the stand 21. In the case of a suspended cymbal 20.1, as is shown in FIG. 4, the protrusion is of a threaded configuration, and extends through the cymbal in order in use to be engaged by a locking configuration (not shown).

The mounting device 10 includes a body 30 that consists of a rod member 33 and a tubular member 43. An end of the rod defines a second end zone 31 of the mounting device, which terminates in a threaded adapter 32 suitable for receiving a complimentary adapter on a microphone and/or a microphone holder. An opposite end of the tubular member 43 defines a second end zone 41 that terminates in an engagement formation 42 suitable for engaging the cymbal stand 21. The rod 33 and the tubular member 43 is configured and dimensioned so as to be telescopically displaceable relative to one another, in order for the body 30 to be displaceable between a retracted position wherein the first end zone 41 and the second end zone 31 are displaced towards one another, and an extended position wherein the end zones are displaced away from one another. A fastener 44 is provided for locking the rod 33 and the tubular member 43 relative to one another, so as to secure the mounting device in a selected position at or between the extended and retracted positions. The fastening arrangement 44 is typically in the form of a threaded fastener that engages a complementary threaded aperture provided in the tubular member 43, an end of the fastener abutting the rod 33 so as to prevent the rod 33 from being displaced relative to the tubular member 43.

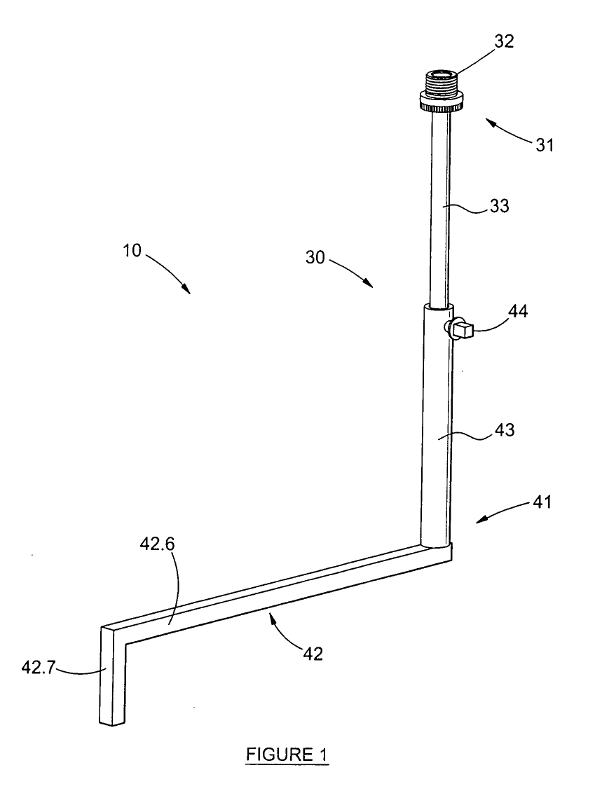

A first embodiment of the engagement formation 42 of the mounting device 10 is shown in FIG. 1. In this embodiment the engagement formation 42 comprises an L-shaped extension 42.6 that terminates in a locating formation 42.7, which is preferably substantially square in cross-section. In use, as is seen in FIG. 2, the locating formation 42.7 engages a complimentary profiled receiving formation 42.8 provided on a clamping member being secured to the cymbal stand 21. The clamping member can be of many different configurations, provided that it includes a suitable receiving formation for receiving the locating formation 42.7 of the mounting device 10. In FIG. 2 the mounting device is shown having been secured to a cymbal stand 21 of a hi-hat cymbal arrangement 20.2. The height of the microphone 15 can now be adjusted relative to the cymbal 20.2 by altering the distance between the first end zone 41 and the second end zone 31 of the mounting device 10.

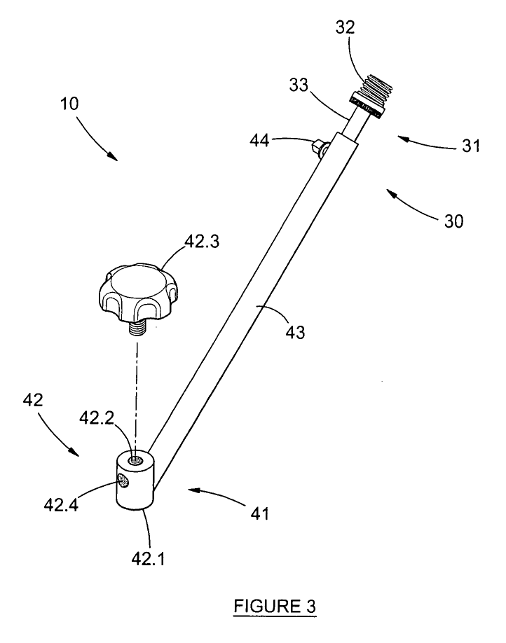

The second embodiment of the mounting device 10 in accordance with the invention is shown in FIGS. 3 and 4, and is typically used for mounting a microphone assembly 30 to a suspended cymbal 20.1, as is shown in FIG. 5. As was the case for the above embodiment, a cymbal 20.1 is attached to a cymbal stand 21, which stand includes a base 21.1, a telescopically extendable shaft 21.2 as well as an end 21.3 from which a threaded protrusion (not shown) extends so as to receive an aperture in the bell of the cymbal 20.1 thereon. Once the cymbal 20.1 has been positioned on the threaded protrusion (not shown), the microphone mounting device 10 is secured to the protrusion, thus serving in securing the cymbal in position whilst also providing a mounting device for mounting a microphone.

In this embodiment of the invention the mounting device 10 again includes the body 30, comprising a rod 33 that is slideably receivable within a tubular member 43. A first end zone 41 is defined by an end of the tubular member 43, which more particularly terminates in an engagement formation 42 described in more detail herein below. The second end zone 31 is defined by the end of the rod 33, which terminates in a threaded adapter 32 suitable for receiving a microphone and/or a microphone holder.

The engagement formation 42 of this embodiment consists of a tubular body 42.1 having a threaded aperture 42.2 provided therethrough, the threaded aperture 42.2 being configured to engage the threaded protrusion (not shown) extending from the end 21.3 of the cymbal stand 21. Once the cymbal 20.1 has been located on the protrusion (not shown) the tubular body 42.1 is secured to the threaded protrusion (not shown) by rotating the tubular body relative to the cymbal stand 21. Once a required position of the mounting device 10 relative to the cymbal arrangement 20.1 has been reached, a threaded locking member 42.3 engages the threaded aperture 42.2 from a direction opposite that of the protrusion member, until such threaded locking member 42.3 abuts an end of the protrusion. In this way, the mounting device 10 is locked in position relative to the cymbal arrangement 20.1, whilst simultaneously securing the cymbal 20.1 to the cymbal stand 21. A microphone assembly 13 can now be secured to the mounting device 10, and again the first end zone 41 and the second end zone 31 can be displaced between the retracted (FIG. 3) and extended (FIG. 4) positions in order to adjust the position of the microphone assembly 13 relative to the cymbal 20.1.

The inventor foresees that the mounting device 10 of this invention will substantially alleviate the disadvantages experienced with existing mounting devices for microphones, and in particular that experienced when using free-standing microphone stands. In both embodiments of the invention the mounting device 10 is easy to install and is secured to a part of the cymbal stand 21, irrespective of whether it is the stand itself or the threaded protrusion extending therefrom. This allows for a more compact assembly which is less space consuming, and easier and quicker to set up. Also, the mounting device 10 is in itself compact and easily transportable. The telescopic displacement of the first and second end zones relative to one another allows for sufficient flexibility insofar as the positioning of the microphone relative to the cymbal is concerned.

It will be appreciated that the above are only two embodiments of this invention and that there may be many variations in detail without departing from the spirit and/or the scope of the invention.

1. A microphone mounting device, suitable for being connected to a cymbal arrangement that includes at least one cymbal and a cymbal stand, the mounting device including:
a body having a first end zone and a second end zone; the first end zone having an engagement formation provided thereon for engaging the cymbal stand; and the second end zone including a threaded connector suitable for engaging a microphone assembly;
the first end zone and the second end zone being displaceable relative to one another.

2. The microphone mounting device of claim 1 wherein the first end zone and the second end zone are telescopically displaceable relative to one another in order for the mounting device to be displaceable between a retracted position, wherein the first end zone and the second end zone are displaced towards one another, and an extended position, wherein the first end zone and the second end zone are displaced away from one another.

3. The microphone mounting device of claim 2 wherein the mounting device is lockable in any selected position at or between the retracted and extended positions.

4. The microphone mounting device of claim 1 wherein the body of the mounting device includes a tubular member and a rod member, the first end zone being located at an end of one of the members, and the second end zone being located at an end of the other of the members.

5. The microphone mounting device of claim 4 wherein the first end zone is located at the end of the tubular member, and the second end zone at the end of the rod member.

6. The microphone mounting device of claim 4 wherein the rod member is slideable within the tubular member so as to allow the first end zone to be telescopically displaceable relative to the second end zone.

7. The microphone mounting device of claim 1 wherein the engagement formation is in the form of a tubular body having a threaded aperture provided therethrough, the tubular body being adapted to engage a complementary threaded protrusion extending through the cymbal.

8. The microphone mounting device of claim 7 including a locking member that is adapted to engage the threaded aperture of the tubular body once the mounting device has been installed on the threaded protrusion so as to lock the mounting device in position relative to the protrusion and thus the stand.

9. The microphone mounting device of claim 7 wherein the tubular body of the engagement formation is angularly offset relative to the body of the mounting device.

10. The microphone mounting device of claim 1 wherein the engagement formation includes a locating formation suitable for locating in a complementary profiled receiving formation provided on a clamping member secured to the cymbal stand.

11. The microphone mounting device of claim 10 wherein the locating formation is in the form of an end of a substantially L-shaped extension extending from the body of the mounting device.

12. The microphone mounting device of claim 11 wherein the L-shaped extension is substantially square in cross-section.
